(19) United States
(12) Patent Application Publication
(10) Pub. No.: US 2018/0248240 A1
(43) Pub. Date: Aug. 30, 2018

(54) COMPACT ANTENNA FEEDER WITH DUAL POLARIZATION

(71) Applicants: Zhiping FENG, Chapel Hill, NC (US); ZTE CORPORATION, Shenzhen (CN)

(72) Inventors: Zhiping FENG, Chapel Hill, NC (US); Ed John NEALIS, Cary, NC (US); Zhuo LI, Xi'an (CN); Ying SHEN, Chapel Hill, NC (US)

(21) Appl. No.: 15/757,255

(22) PCT Filed: Sep. 1, 2016
(86) PCT No.: PCT/US2016/049953

§ 371 Date: Mar. 2, 2018

Related U.S. Application Data
(60) Provisional application No. 62/213,523, filed on Sep. 2, 2015.

(51) Int. Cl. H01P 1/165; H01P 1/38; H01P 1/36; H01Q 19/13; H04B 7/0408

(52) U.S. Cl. CPC H01P 1/165; H01P 1/38; H04B 7/0408; H01Q 19/13; H01P 1/36

(57) ABSTRACT

A compact antenna feeder and associated circulator plate are disclosed. The antenna feeder includes: an orthomode transducer (OMT) polarizer, a first circulator and a second circulator. The OMT -polarizer includes a septum, a first port, a second port, and a third port. The first circulator is coupled to the first port of the OMT polarizer to define one orthogonally polarized microwave signal path between the first circulator and the third port of the OMT-polarizer. The second circulator is coupled to the second port of the OMT polarizer to define another orthogonally polarized microwave signal path between the second circulator to the third port of the OMT-polarizer. The OMT polarizer includes a waveguide with the septum located therein separating the two orthogonally polarized microwave signal paths. The septum has a base mounted on the circulator plate and a step-shape body extending from the base and out of the circulator plate.

### TECHNICAL FIELD

The present application generally relates to devices for wireless communications, and more particularly, to a compact antenna feeder with dual polarization used in a two-transmitter two-receiver (2T2R) digital microwave radio.

### BACKGROUND

Microwave radio plays an increasingly important role in the backhaul connectivity of wireless communications. A two-transmitter two-receiver (2T2R) digital microwave radio in one enclosure provides advantages such as increased capacity and coverage of microwave radios and reduced cost over the traditional one-transmitter one-receiver (1T1R) system design. A typical 2T2R system includes an antenna coupling unit with integrated circulators and isolators, which is also referred to as “circulator plate”. The conventional 2T2R system design typically has an external polarizer coupling the circulator plate to an antenna, which not only increases the overall system size but also increases the system's insertion loss and return loss as well as manufacturing cost and complexity.

### SUMMARY

An object of the present application is to develop a compact dual-polarization antenna feeder for a 2T2R digital microwave radio system that integrates an orthomode transducer (OMT) polarizer with a circulator plate.

According to a first aspect of the present application, an antenna feeder includes an orthomode transducer (OMT) polarizer, a first circulator and a second circulator. The OMT polarizer includes a septum, a first port, a second port, and a third port. The first circulator is coupled to the first port of the OMT polarizer and the second circulator is coupled to the second port of the OMT polarizer. Both the first and second circulators are formed using a single circulator plate. The septum in the OMT polarizer has a base mounted on the circulator plate and a step-shape body extending from the base and out of the circulator plate.

According to a second aspect of the present application, an antenna coupling unit includes a first filter, a second filter, a third filter, and a fourth filter, each filter having an input port and an output port, an orthomode transducer (OMT) polarizer, and a circulator plate that is coupled to the OMT polarizer. The OMT polarizer includes a septum, a first port, a second port, and a third port. The circulator plate includes a first circulator including a first port, a second port, and a third port, and a second circulator including a first port, a second port, and a third port. The first port of the first circulator is coupled to the output port of the first filter, the second port of the first circulator is coupled to the first port of the OMT polarizer, and the third port of the first circulator is coupled to the input port of the second filter. The first port of the second circulator is coupled to the output port of the third filter, the second port of the second circulator is coupled to the second port of the OMT polarizer, and the third port of the second circulator is coupled to the input port of the fourth filter. The septum in the OMT polarizer has a base mounted on the circulator plate and a step-shape body extending from the base and out of the circulator plate.

According to a third aspect of the present application, a two-transmitter two-receiver (2T2R) digital microwave radio includes a communication interface unit, communication circuitry coupled to the communication interface unit, and an antenna coupling unit coupled to the communication circuitry. The antenna coupling unit further includes a first filter, a second filter, a third filter, and a fourth filter, each filter having an input port and an output port, an orthomode transducer (OMT) polarizer, and a circulator plate coupled to the OMT polarizer. The circulator plate further includes a first circulator including a first port, a second port, and a third port, and a second circulator including a first port, a second port, and a third port. The first port of the first circulator is coupled to the output port of the first filter, the second port of the first circulator is coupled to the first port of the OMT polarizer, and the third port of the first circulator is coupled to the input port of the second filter. The first port of the second circulator is coupled to the output port of the third filter, the second port of the second circulator is coupled to the second port of the OMT polarizer, and the third port of the second circulator is coupled to the input port of the fourth filter. The septum in the OMT polarizer has a base mounted on the circulator plate and a step-shape body extending from the base and out of the circulator plate.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles. Like reference numerals refer to corresponding parts.

FIG. 1 is a schematic diagram illustrating a two-transmitter two-receiver (2T2R) device including a circulator plate integrated with an OMT polarizer in accordance with some implementations.

FIGS. 2A through 2D are 3-D perspective views of a circulator plate including multiple circulators and isolators and an OMT polarizer including a septum mounted on the circulator plate at different manufacturing stages in accordance with some implementations.

FIGS. 3A and 3B are 3-D perspective views depicting two embodiments of the septum having different transitions in accordance with some implementations.

FIGS. 4A and 4B are 3-D perspective views depicting two embodiments of an OMT polarizer including the septum in accordance with some implementations.

FIG. 5 is a perspective view of an antenna feeder integrating an OMT polarizer with two circulators in accordance with some implementations.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of claims and the subject matter may be practiced without these specific details. For example, it will be apparent to one of ordinary skill in the art that the subject matter presented herein can be implemented on many types of radio communication systems.

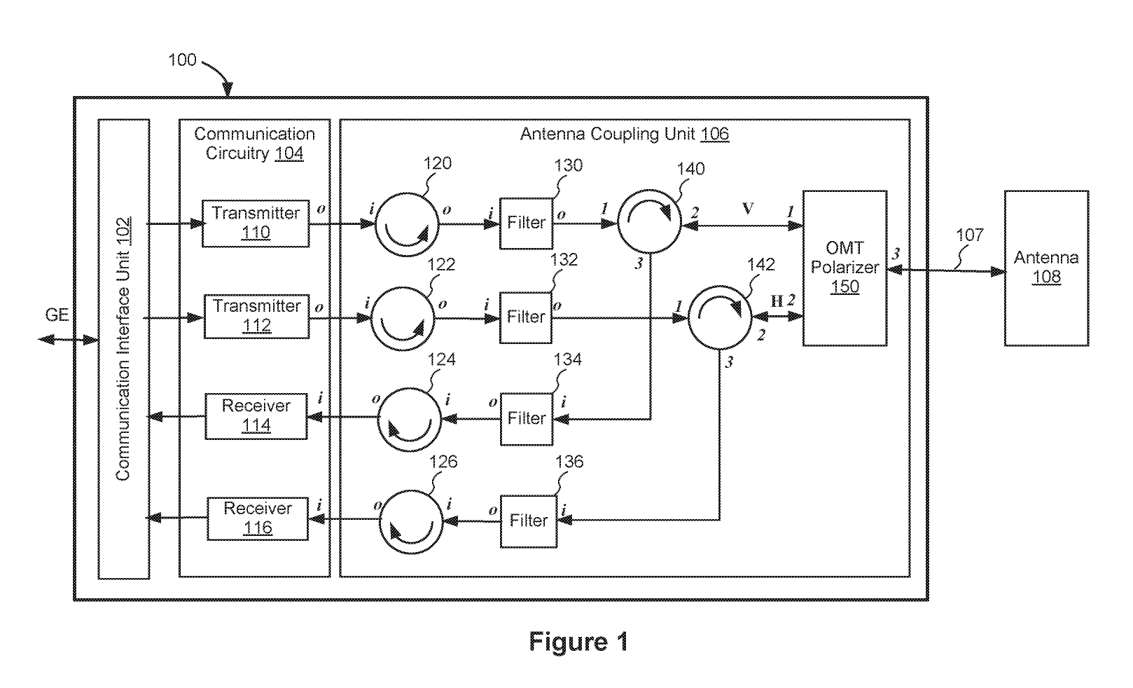

FIG. 1 is a schematic diagram illustrating a two-transmitter two-receiver (2T2R) digital microwave radio 100 including a communication interface unit 102, communication circuitry 104 coupled to the communication interface unit 102, and an antenna coupling unit 106 coupled to the communication circuitry 104. The 2T2R digital microwave radio 100 is communicatively coupled to an antenna 108 via a waveguide 107. Various implementation details of the different components within the 2T2R digital microwave radio 100 can be found in U.S. patent application Ser. No. 14/332,316, entitled “Compact Dual All-Outdoor Point-To-Point Microwave Radio Architecture” filed on Jul. 15, 2014, which is incorporated herein by reference in its entirety.

As shown in FIG. 1, the communication circuitry 104 includes a first transmitter 110, a second transmitter 112, a first receiver 114, and a second receiver 116, each transmitter/receiver having an input port and an output port. In this example, the input port (labeled “i” in the figure) of the first transmitter 110 is coupled to the communication interface unit 102 (or more specifically, an analog front end therein but not shown in the figure) and the output port (labeled “o” in the figure) of the first transmitter 110 is coupled to the input port of a first isolator 120 in the antenna coupling unit 106. The input port of the second transmitter 112 is coupled to the communication interface unit 102 (or more specifically, an analog front end therein but not shown in the figure) and the output port of the second transmitter 112 is coupled to a third isolator 122 in the antenna coupling unit 106. The output port of the first receiver 114 is coupled to the communication interface unit 102 (or more specifically, an analog front end therein but not shown in the figure) and the input port of the first receiver 114 is coupled to a second isolator 124 in the antenna coupling unit 106. The output port of the second receiver 116 is coupled to the communication interface unit 102 (or more specifically, an analog front end therein but not shown in the figure) and the input port of the second receiver 116 is coupled to a fourth isolator 126 in the antenna coupling unit 106.

Within the antenna coupling unit 106, the output port of the first isolator 120 is coupled to the input port of a first filter 130 and the output port of the third isolator 122 is coupled to the input port of a third filter 132. The input port of the second isolator 124 is coupled to the output port of a second filter 134 and the input port of the fourth isolator 126 is coupled to the output port of a fourth filter 136. The output port of the first filter 130 and the input port of the second filter 134 are coupled to the first (labeled “1” in the figure) and third (labeled “3” in the figure) ports of a first circulator 140, respectively. The output port of the third filter 132 and the input port of the fourth filter 136 are coupled to the first and third ports of a second circulator 142, respectively. The second (labeled “2” in the figure) port of the first circulator 140 and the second port of the second circulator 142 are coupled to the first and second ports of the OMT polarizer 150, respectively. In this example, there are two orthogonally polarized microwave signal paths within the OMT polarizer 150. The first port of the OMT polarizer 150 is used for the vertical component of the microwave signal traveling through one of the two orthogonally polarized microwave signal paths and the second port of the OMT polarizer 150 is used for the horizontal component of the microwave signal traveling through the other one of the two orthogonally polarized microwave signal paths.

As shown in FIG. 1, microwave signals or radio-frequency (RF) signals are transmitted back and forth between devices (not shown) coupled to the communication interface unit 102 and the antenna 108 coupled to the OMT polarizer 150 through corresponding signal paths. Note that an isolator is configured to suppress microwave signals or RF signals received through the output port of the isolator from being output through the input port of the isolator. A circulator is configured to route microwave signals or RF signals received through its first port to the second port of the circulator (e.g., toward the antenna), and microwave signals or RF signals received through the second port (e.g., from the antenna) to the third port of the circulator. In some implementations, the circulator is configured to route microwave signals or RF signals received through its third port to the first port of the circulator. Because a significant portion (e.g., 90%) of the signals received through the first port are output through the second port of the circulator and a significant portion of the signals from the antenna received through the second port are output through the third port of the circulator, the circulator can reduce the signal loss associated with routing the microwave signals or RF signals.

In some implementations, the first and third filters 130 and 132 are transmitter filters (also called transmission filters). A transmitter filter is configured to output RF or microwave signals that satisfy a predetermined RF or microwave band through the output port of the transmitter filter. The transmitter filter is configured to suppress RF or microwave signals that do not satisfy the predetermined RF or microwave band from being output through the output port of the transmitter filter. In some implementations, the transmitter filter is configured to send back (e.g., by reflection) RF or microwave signals that do not satisfy the predetermined RF or microwave band through the input port of the transmitter filter. In some implementations, the transmitter filter is a tunable filter and the corresponding predetermined RF or microwave band is tunable.

In some implementations, the second and fourth filters 134 and 136 are receiver filters (also called reception filters). A receiver filter is configured to output RF or microwave signals that satisfy a predetermined RF or microwave band through the output port of the receiver filter. The receiver filter is configured to suppress RF or microwave signals that do not satisfy the predetermined radio-frequency or microwave band from being output through the output port of the receiver filter. In some implementations, the receiver filter is a tunable filter and the corresponding predetermined RF or microwave band is tunable. In some implementations, the predetermined RF or microwave band associated with the receiver filter is distinct from the predetermined radio-frequency or microwave band associated with the transmitter filter. For example, the predetermined RF or microwave band associated with the receiver filter does not overlap with the predetermined RF or microwave band associated with the transmitter filter.

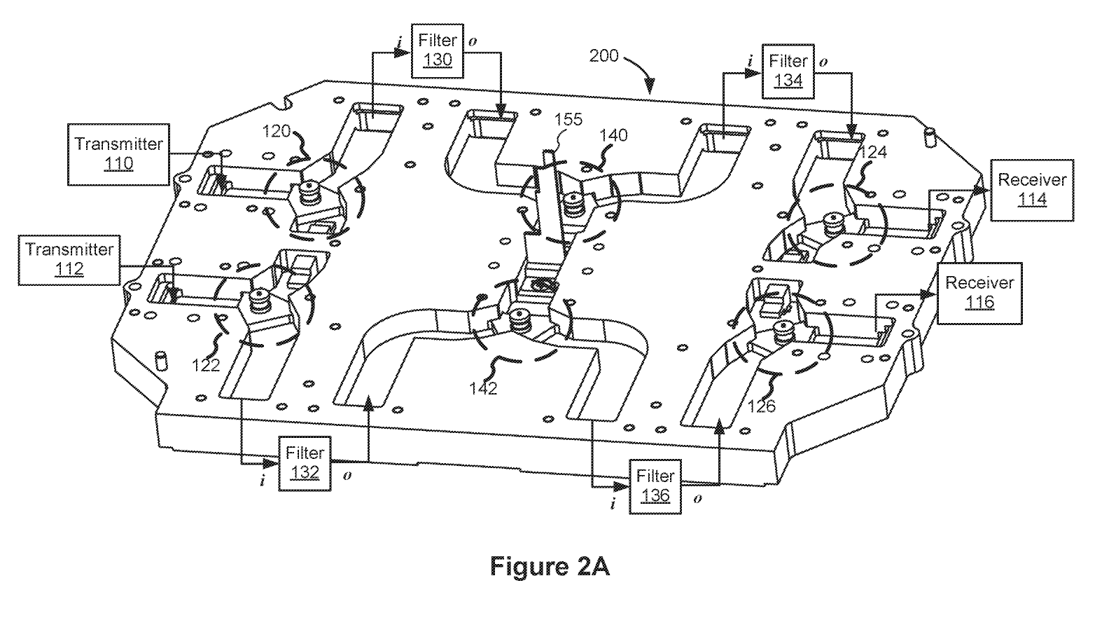

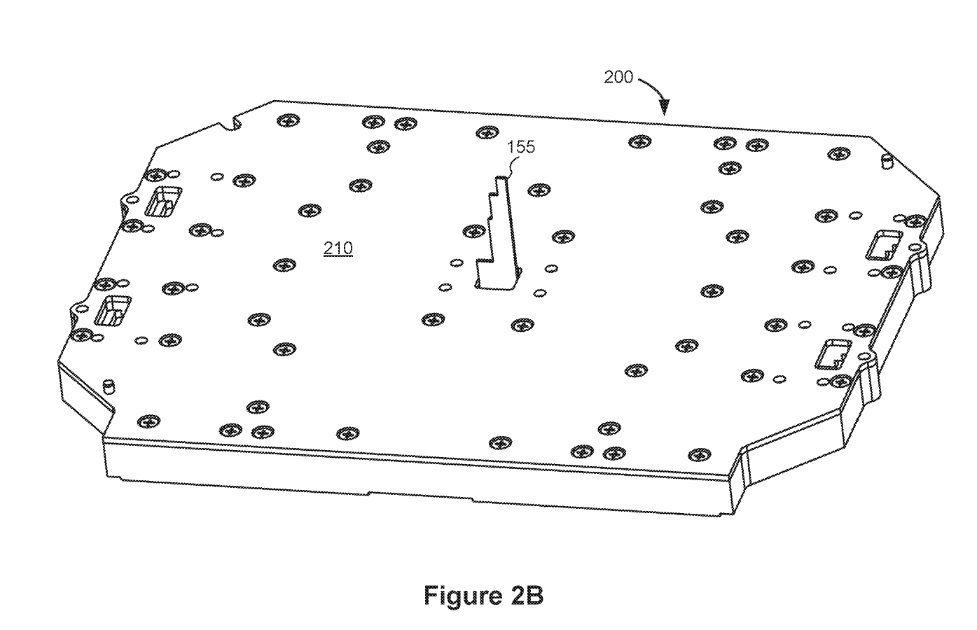

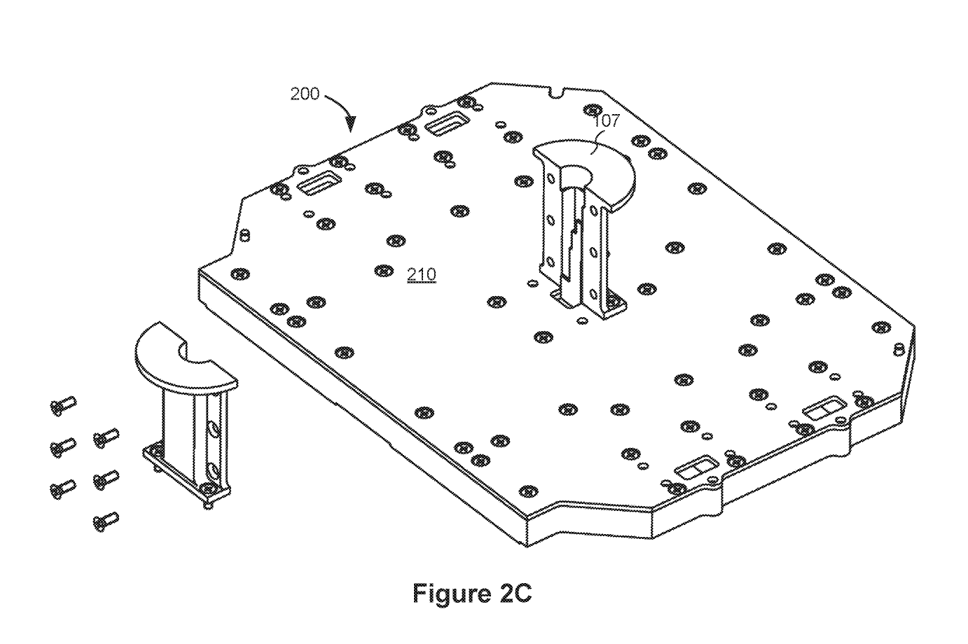

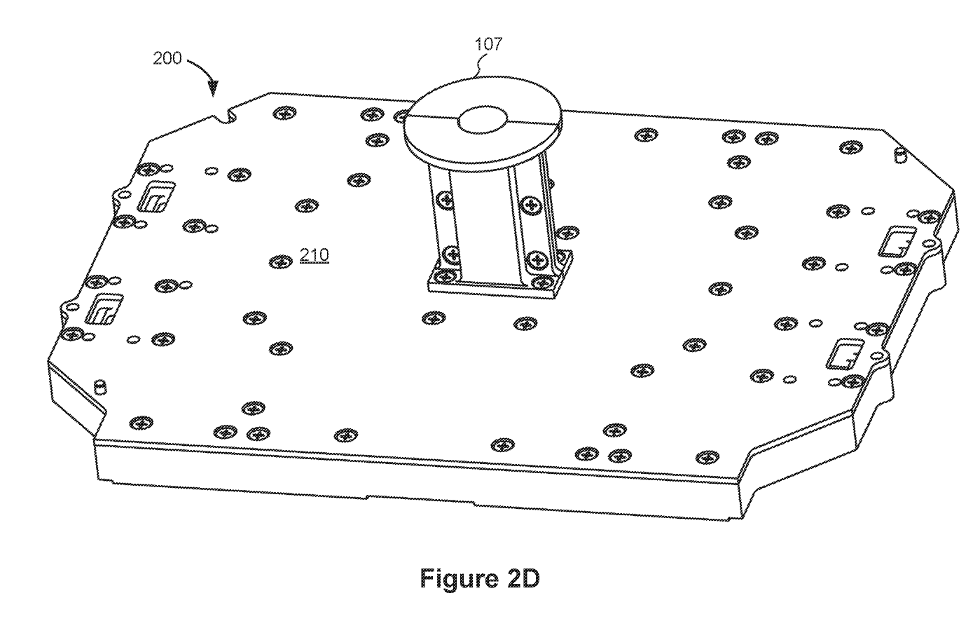

In some implementations, the four isolators 120, 122, 124, 126 and two circulators 140, 142 shown in FIG. 1 are formed using a single plate. As used herein, the single plate has a flat shape. FIG. 2A is a 3-D perspective view of an exemplary circulator plate 200 that is used for forming the four isolators 120, 122, 124, and 126 and the two circulators 140 and 142, and integrates with the OMT polarizer 150. In some implementations, the OMT polarizer 150 integrated with the circulator plate 200 can reduce both the insertion loss and return loss of the 2T2R digital microwave radio 100. As described below, different portions of the circulator plate 200 correspond to different elements in the antenna coupling unit 106 as discussed with reference to FIG. 1. In some implementations, the circulator plate 200 is made of a conductive material (e.g., aluminum) or a conductively plated material.

In this example, microwave or RF signals output from the first transmitter 110 are sent to the first isolator 120. The first isolator 120 receives the microwave or RF signals from the first transmitter 110 and routes the microwave or RF signals to the first filter 130 through the output port of the first isolator 120. Signals at the first port of the first circulator 140 are then routed to the second port of the first circulator 140 and propagated into the first port of the OMT polarizer 150. In some implementations, the OMT polarizer 150 is a waveguide including a septum 155 that splits the waveguide into two orthogonally polarized microwave signal paths (note that only the septum 155 is shown in FIG. 2A for illustrative purposes). Signals arriving at the first port of the OMT polarizer 150 are propagated through the OMT polarizer 150 along one signal path and arrive at the third port and then transmitted into the antenna 108 through the waveguide 107.

Similarly, microwave or RF signals output from the second transmitter 112 are sent to the third isolator 122. The third isolator 122 receives the signals from the second transmitter 112 and routes the signals to the third filter 132 through the output port of the third isolator 122. Signals at the first port of the second circulator 142 are then routed to the second port of the second circulator 142 and propagated into the second port of the OMT polarizer 150. Signals arriving at the second port of the OMT polarizer 150 are propagated through the OMT polarizer 150 along one signal path and arrive at the third port and then transmitted into the antenna 108 through the waveguide 107.

Microwave or RF signals coming from the antenna 108 through the waveguide 107 are propagated through the OMT polarizer 150 along one or two signal paths therein and come out of the OMT polarizer 150 at the first and second ports. For example, the vertical component is propagated along one signal path and comes out of the first port of the OMT polarizer 150 and then enters the first circulator 140 through its second port and then routed to the input port of the second filter 134 through the third port of the first circulator 140. The signals are then routed to the input port of the second isolator 124 through the output port of the second filter 134. Next, the signals are received by the first receiver 114 from the output port of the second isolator 124 and then enter into the communication interface unit 102. Similarly, the horizontal component is propagated along one signal path within the OMT polarizer 150 and comes out of the second port of the OMT polarizer 150 and then enters the second circulator 142 through its second port and then routed to the input port of the fourth filter 136 through the third port of the second circulator 142. The signals are then routed to the input port of the fourth isolator 126 through the output port of the fourth filter 136. Next, the signals are received by the second receiver 116 from the output port of the fourth isolator 126 and then enter into the communication interface unit 102.

FIG. 2B is another 3-D perspective view of the circulator plate 200 after a cover 210 is mounted on the circulator plate 200. Note that the cover 210 has an opening near its center allowing the septum 155 to extend out of the circulator plate 200. FIGS. 2C and 2D further depict that a waveguide 107 (which has two halves) is mounted on the cover 210 and around the septum 155. As noted above in connection with FIG. 1, the waveguide 107 is responsible for coupling the circulator plate 200 to an antenna 108.

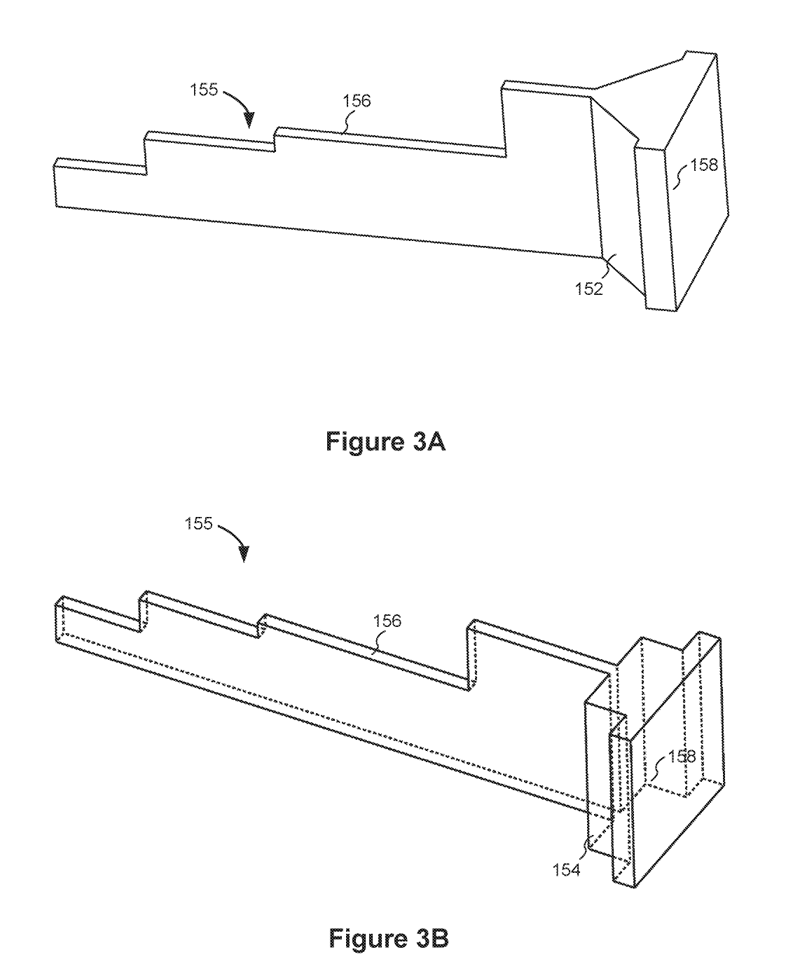

As shown in FIG. 3A, the septum 155 has a symmetrical structure including a base mounted on the circulator plate 200 and a step-shape body extending from the base and out of the circulator plate 200. There is a transition between the base and the step-shape body. Research indicates that the shape of the transition affects the efficiency of the septum 155 when microwave or RF signals are routed through the OMT polarizer 150. FIGS. 3A and 3B are 3-D perspective views depicting two embodiments of the septum having different transitions in accordance with some implementations. In particular, the septum 155 shown in FIG. 3A has a septum body 156 and a base 158. A symmetrical, slope transition 152 connects the base 158 and the septum body 156 together. Similarly, the septum 155 shown in FIG. 3B also has a septum body 156 and a base 158. A symmetrical, step transition 154 connects the base 158 and the septum body 156 together. Computer simulation results suggest that these two septum transition designs can reduce both the insertion loss and return loss of the OMT polarizer.

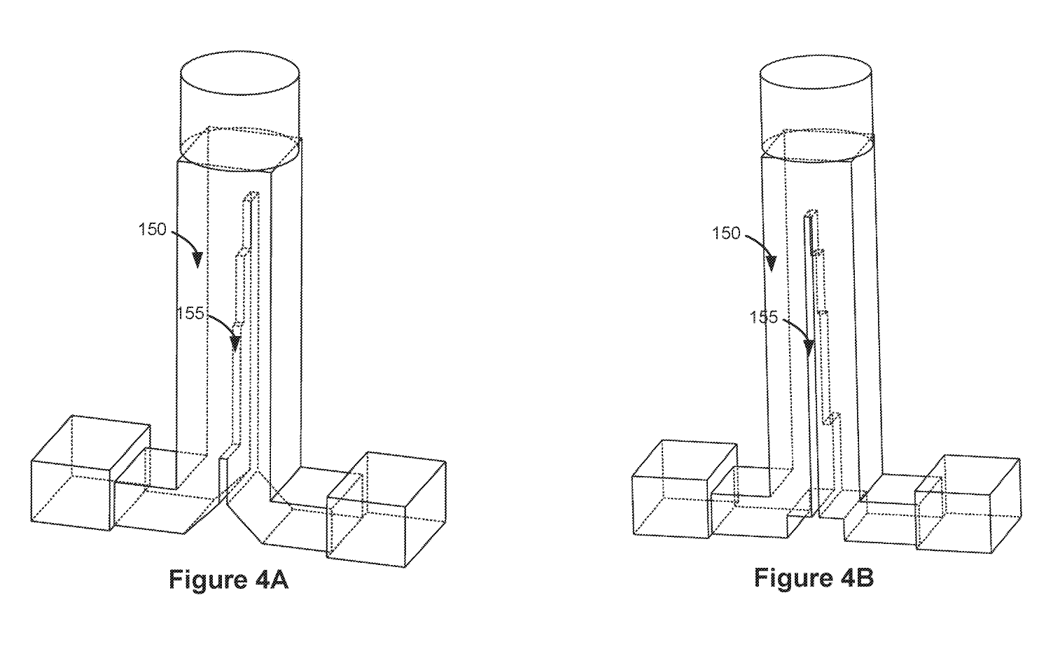

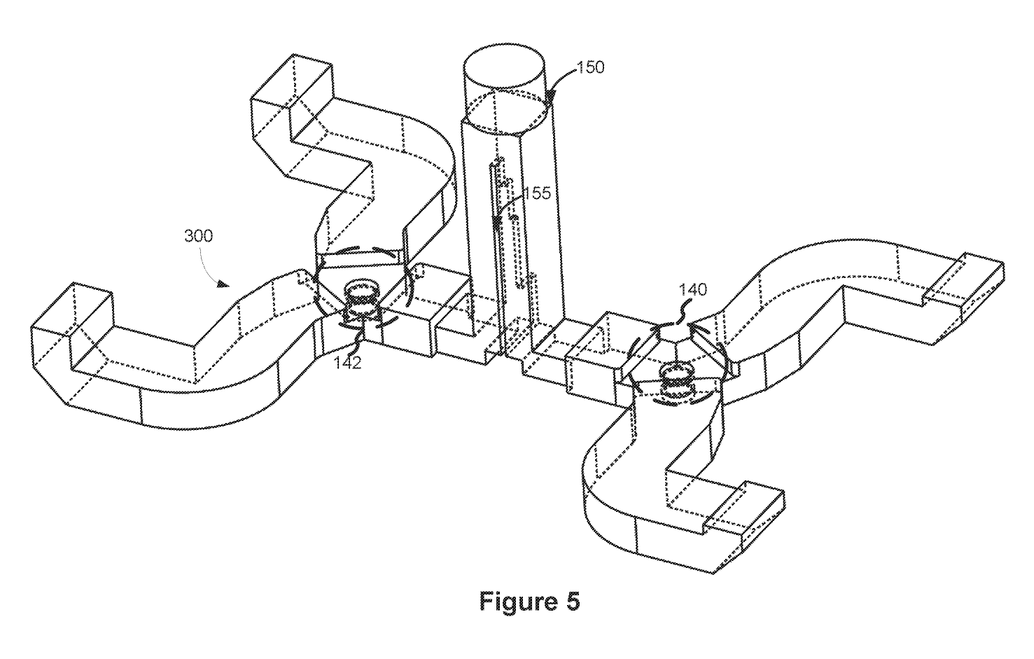

FIGS. 4A and 4B are 3-D perspective views depicting two embodiments of an OMT polarizer including the septum having different transitions in accordance with some implementations. In particular, the OMT 150 shown in FIG. 4A includes a septum 155 having a slope transition and the OMT 150 shown in FIG. 4B includes a septum 155 having a step transition. FIG. 5 is a perspective view of an antenna feeder 300 integrating an OMT polarizer 150 with two circulators 140, 142 in accordance with some implementations. In particular, the OMT polarizer 150 includes a septum 155, a first port, a second port, and a third port. Note that both the first port and the second port of the OMT polarizer 150 are located on the same plane as the first circulator 140 and the second circulator 142. In some implementations as described above, they are formed using a single circulator plate. The third port of the OMT polarizer 150, which is not on the same plane, is connected to the circulator plate via a waveguide. The first port of the OMT polarizer 150 is coupled to the second port of the first circulator 140 and the second port of the OMT polarizer 150 is coupled to the second port of the second circulator 142 to route microwave or RF signals coming from different directions through the OMT polarizer 150 in a more efficient manner.

Various embodiments of the antenna feeder design as discussed in the present disclosure can be used in digital microwave radios, such as 2T2R digital microwave radios. The compact antenna feeder can be designed for different frequency bands. Such design can reduce the overall size of the dual polarization antenna feeder and improves the isolation by introducing additional circulators and isolators into the antenna feeder. Moreover, the manufacturing and assemble cost is also reduced due to a simple manufacturing and assemble process based on the new design.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

As used herein, the terms “couple,” “coupling,” and “coupled” are used to indicate that multiple components are connected in a way such that a first component of the multiple components is capable of receiving a signal from a second component of the multiple components, unless indicated otherwise. In some cases, two components are indirectly coupled, indicating that one or more components (e.g., filters, waveguides, etc.) are located between the two components but a first component of the two components is capable of receiving signals from a second component of the two components.

Many modifications and alternative embodiments of the embodiments described herein will come to mind to one skilled in the art having the benefit of the teachings presented in the foregoing descriptions and the associated drawings. Therefore, it is to be understood that the scope of claims are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The embodiments were chosen and described in order to best explain the underlying principles and their practical applications, to thereby enable others skilled in the art to best utilize the underlying principles and various embodiments with various modifications as are suited to the particular use contemplated.

What is claimed is:

1. An antenna feeder, comprising:
an orthomode transducer (OMT) polarizer, the OMT polarizer including a septum, a first port, a second port, and a third port;
a first circulator, wherein the first circulator is coupled to the first port of the OMT polarizer; and
a second circulator, wherein the second circulator is coupled to the third port of the OMT polarizer.

2. The antenna feeder of claim 1, wherein the first circulator and the second circulator are formed using a single circulator plate.

3. The antenna feeder of claim 2, wherein the septum has a base mounted on the circulator plate and a step-shape body extending from the base and out of the circulator plate.

4. The antenna feeder of claim 3, wherein the base has two transitions facing opposite directions, each transition being one selected from the group consisting of a slope transition and a step transition.

5. The antenna feeder of claim 1, wherein the OMT polarizer includes a waveguide with the septum located therein splitting the waveguide into two orthogonally polarized microwave signal paths.

6. The antenna feeder of claim 3, wherein one of the two orthogonally polarized microwave signal paths is a path between the first port and the third port of the OMT polarizer and the other one of the two orthogonally polarized microwave signal paths is a path between the second port and the third port of the OMT polarizer.

7. An antenna coupling unit, comprising:
a first filter, a second filter, a third filter, and a fourth filter, each filter having an input port and an output port;
an orthomode transducer (OMT) polarizer, the OMT polarizer including a septum, a first port, a second port, and a third port; and
a circulator plate that is coupled to the OMT polarizer, the circulator plate further including:
a first circulator including a first port, a second port, and a third port, wherein the first port of the first circulator is coupled to the output port of the first filter, the second port of the first circulator is coupled to the first port of the OMT polarizer, and the third port of the first circulator is coupled to the input port of the second filter; and
a second circulator including a first port, a second port, and a third port, wherein the first port of the second circulator is coupled to the output port of the third filter, the second port of the second circulator is coupled to the second port of the OMT polarizer, and the third port of the second circulator is coupled to the input port of the fourth filter.

8. The antenna coupling unit of claim 7, further comprising:
a first insulator including an input port and an output port, the input port being coupled to a first transmitter and the output port being coupled to the input port of the first filter;
a second insulator including an input port and an output port, the input port being coupled to the output port of the second filter and the output port being coupled to a first receiver;
a third insulator including an input port and an output port, the input port being coupled to a second transmitter and the output port being coupled to the input port of the third filter; and
a fourth insulator including an input port and an output port, the input port being coupled to the output port of the fourth filter and the output port being coupled to a second receiver.

9. The antenna coupling unit of claim 7, wherein:
the first transmitter and the second transmitter are located outside the circulator plate; and
the first receiver and the second receiver are located outside the circulator plate.

10. The antenna coupling unit of claim 7, wherein the first circulator, the second circulator, the first isolator, the second isolator, the third isolator, and the fourth isolator are formed using a single plate.

11. The antenna coupling unit of claim 7, wherein the OMT polarizer includes a waveguide extending out of the circulator plate with the septum located therein splitting the waveguide into two orthogonally polarized microwave signal paths.

12. The antenna coupling unit of claim 11, wherein one of the two orthogonally polarized microwave signal paths is a path between the first port and the third port of the OMT polarizer and the other one of the two orthogonally polarized microwave signal paths is a path between the second port and the third port of the OMT polarizer.

13. The antenna coupling unit of claim 7, wherein the septum has a base mounted on the circulator plate and a step-shape body extending from the base and out of the circulator plate.

14. The antenna coupling unit of claim 13, wherein the base has two transitions facing opposite directions, each transition being one selected from the group consisting of a slope transition and a step transition.

15. A two-transmitter two-receiver (2T2R) digital microwave radio, comprising:
a communication interface unit;
communication circuitry configured to be coupled to the communication interface unit; and
an antenna coupling unit configured to be coupled to the communication circuitry, the antenna coupling unit further comprising:
a first filter, a second filter, a third filter, and a fourth filter, each filter having an input port and an output port;
an orthomode transducer (OMT) polarizer, the OMT polarizer including a septum, a first port, a second port, and a third port; and
a circulator plate that is coupled to the OMT polarizer, the circulator plate further including:
a first circulator including a first port, a second port, and a third port, wherein the first port of the first circulator is coupled to the output port of the first filter, the second port of the first circulator is coupled to the first port of the OMT polarizer, and the third port of the first circulator is coupled to the input port of the second filter; and
a second circulator including a first port, a second port, and a third port, wherein the first port of the second circulator is coupled to the output port of the third filter, the second port of the second circulator is coupled to the second port of the OMT polarizer, and the third port of the second circulator is coupled to the input port of the fourth filter.

16. The 2T2R digital microwave radio of claim 15, wherein the communication circuitry further including a first transmitter, a second transmitter, a first receiver, and a second receiver, respectively.

17. The 2T2R digital microwave radio of claim 16, wherein the antenna coupling unit further comprises:
a first insulator coupling the first transmitter to the first filter;
a second insulator coupling the first receiver to the second filter;
a third insulator coupling the second transmitter to the third filter; and
a fourth insulator coupling the second receiver to the fourth filter.

18. The 2T2R digital microwave radio of claim 17, wherein the first circulator, the second circulator, the first isolator, the second isolator, the third isolator, and the fourth isolator are formed using a single plate.

19. The 2T2R digital microwave radio of claim 15, wherein the OMT polarizer includes a waveguide extending out of the circulator plate with the septum located therein splitting the waveguide into two orthogonally polarized microwave signal paths.

20. The 2T2R digital microwave radio of claim 19, wherein one of the two orthogonally polarized microwave signal paths is a path between the first port and the third port of the OMT polarizer and the other one of the two orthogonally polarized microwave signal paths is a path between the second port and the third port of the OMT polarizer.

21. The 2T2R digital microwave radio of claim 15, wherein the septum has a base mounted on the circulator plate and a step-shape body extending from the base and out of the circulator plate.

22. The 2T2R digital microwave radio of claim 21, wherein the base has two transitions facing opposite directions, each transition being one selected from the group consisting of a slope transition and a step transition.
